(19) United States
(12) Patent Application Publication
(10) Pub. No.: US 2015/0067570 A1
(43) Pub. Date: Mar. 5, 2015

(54) Method and Apparatus for Enhancing User Interface in a Device with Touch Screen

(71) Applicants: Jae in Yoon, Centreville, VA (US); Jae Seok Ahn, Arlington, VA (US)

(72) Inventors: Jae in Yoon, Centreville, VA (US); Jae Seok Ahn, Arlington, VA (US)

(21) Appl. No.: 14/018,248

(22) Filed: Sep. 4, 2013

(51) Int. Cl. G06F 3/0484; G06F 3/0488

(52) U.S. Cl. CPC G06F 3/04845; G06F 3/04886; G06F 3/04842
USPC 715/773; 715/815

(57) ABSTRACT

The present invention provides method and apparatus for providing an enhanced user interface at devices equipped with touch screens. The present invention enables users to more easily and accurately select an object among multiple selectable objects competing within limited screen space by enlarging the desired object as user's finger or a stylus pen approaches the object before physically touching it on the touch screen.

### CROSS-REFERENCE TO RELATED APPLICATIONS

Not Applicable

### TECHNICAL FIELD OF THE INVENTION

The present invention relates to a method for an electronic device to provide a user interface via a touch screen.

### BACKGROUND OF THE INVENTION

Recently, as touch input technology has rapidly evolved, many devices using touch screen as a source of user input are commonly found in consumer electronic products. In general, users use their finger(s) to select objects (e.g., buttons, icons, hyperlinks, and etc.) displayed on the touch screen of a mobile device. However, these objects usually are relatively small compared to the users' finger(s). Because of this, users experience difficulties in trying to accurately select the desired object. Especially when multiple selectable objects are competing within limited screen space, accurately selecting the desired object becomes even more difficult. For example, most users have experienced typographical error while writing text messages and/or emails using an on-screen keyboard.

### BRIEF SUMMARY OF THE INVENTION

An exemplary embodiment of the present invention provides method and apparatus that enables users to accurately select desired object among multiple objects displayed on the touch screen.

The first aspect of the present invention provides a method of enlarging an object on the touch screen, in response to detecting the presence of a user's means of touch input within a predetermined proximity to the object displayed on the touch screen with the user's means of touch input not physically touching the touch screen; and one or more predetermined commands associated with the object, in response to a user's touch input entered via the touch screen.

The object is an input key within the on-screen keyboard and it is desirable that executing the one or more predetermined commands comprises entering a value assigned to the input key into a input field.

It is desirable that the touch input method additionally includes automatically activating a function of detecting proximity of the user's means of touch input when the on-screen keyboard is displayed on the touch screen.

It is desirable that enlarging the object includes determining whether the user's means of touch input is within predetermined proximity based on electrostatic changes on the touch screen caused by the user's means of touch input.

It is desirable that enlarging the object includes determining whether the user's means of touch input is within predetermined proximity by using one or more proximity sensors.

It is desirable that enlarging the object includes changing at least one spacing between other objects while the enlarged object is displayed.

It is desirable that enlarging the object includes reducing the size of one or more objects around the enlarged object while the enlarged object is displayed.

In addition, the second aspect of the present invention provides a touch input apparatus comprising: memory unit storing one or more programs; and a process that enlarges the object on the touch screen and executes one or more predetermined commands associated with the enlarged object by executing the one or more program, wherein the one or more program include instructions implementing the steps of: enlarging the object displayed on the touch screen, in response to detecting the presence of a user's means of touch input within a predetermined proximity to an object displayed on the touch screen while not physically touching the touch screen, and executing one or more predetermined commands associated with the object, in response to a touch input entered via the touch screen by the user.

In addition, the third aspect of the present invention provides a computer readable recording medium having embodied thereon a computer program for executing the method of the first aspect.

### BRIEF DESCRIPTION OF THE DRAWINGS

FIG. 1 is a diagram illustrating an overall description of how the touch input apparatus operates according to an embodiment of the present invention;

FIG. 2 is a flow chart which describes step-by-step process of the touch input apparatus acknowledging user's touch input according to an embodiment of the present invention;

FIG. 3 is a diagram illustrating the touch input apparatus sensing user's finger near the touch screen according to an embodiment of the present invention;

FIG. 4 is a diagram illustrating the touch input apparatus which displays an on-screen keyboard and enlarges one of the keys as user's finger approaches and is above the key on the touch screen according to an embodiment of the present invention;

FIG. 5 is a diagram illustrating the touch input apparatus which displays a web page and enlarges a text object of the web page as user's finger approaches the text object on the touch screen according to an embodiment of the present invention;

FIG. 6 is a diagram illustrating the touch input apparatus which displays a settings menu comprising multiple menu items and enlarges one of the items as user's finger comes near the desired item on the touch screen according to an embodiment of the present invention; and

FIG. 7 is a block diagram of the touch input apparatus according to an embodiment of the present invention.

### DETAILED DESCRIPTION OF THE INVENTION

Embodiments of the present invention are described in detail with reference to the accompanying drawing. The embodiments are provided to illustrate aspects of the invention, but the invention is not limited to any embodiment. The scope of the invention encompasses numerous alternatives, modifications and equivalent; it is limited only by the claims. The same or similar components may be designated by the same or similar reference numerals although they are illustrated in different drawings. Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

Throughout the specification, it will also be understood that when an element is referred to as being “connected to” another element, it can be directly connected to the other element, or electrically connected to the other element while intervening elements may also be present. Also, when a part “includes” or “comprises” an element, unless there is a particular description contrary thereto, the part can further include other elements, not excluding the other elements.

Also, throughout the specification, “object” includes any user interface means which is displayed on a touch screen to enable a user to enter commands, instructions or values into the device by touching it. Examples of an object include, but not limited to, icons, buttons, images, and texts.

Also, throughout the specification, that user's finger is near, close to, or in vicinity of an object refers to user's finger being within a predetermined proximity to an object displayed on the touch screen, but not physically touching the touch screen, enabling a device to detect the user's finger.

Also, throughout the specification, touch input apparatus can refer to but not limited to mobile devices such as, smartphones, smart TVs, mobile phones, personal digital assistant (PDA) devices, smart watches, laptop computers, media players, global positioning system (GPS) devices, and can also refer to any fixed devices equipped with touch screen such as, personal computers, electronic whiteboards, touch tables, and large display devices.

In the embodiments described hereinafter, a user uses his/her finger to enter a touch input. However, it should be understood that user's means of touch input is not limited thereto and any other means of input (e.g., stylus pen) can be adopted to implement the present invention. Further, types of touch input include but are not limited to, tap, long touch, multi-touch, and etc.

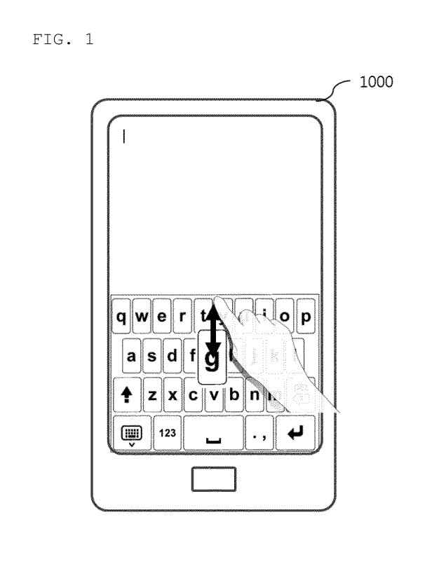

FIG. 1 is a diagram illustrating how the touch input apparatus operates according to an embodiment of the present invention.

As illustrated in FIG. 1, when a user's finger comes close to an object displayed on a touch screen without physically touching it, the closest object (from the user's finger) displayed on the screen, in this case “g” key within the on-screen keyboard, is enlarged. Then, when user actually touches the enlarged object with the finger, the touch input apparatus 1000 executes the command associated with, in other words, pre-assigned to, the touched object.

Hereinafter the description of the present invention will focus on a specific embodiment where an object is enlarged when a user's means of touch input is within a predetermined proximity to the object displayed on a touch screen. However, it should be noted that the subject matter of the present invention broadly lies in every aspects of the invention that enable the target object to stand out, making it easier to choose, before the user actually touches the object displayed on the touch screen. In this light, for example, the present invention can also be implemented by changing not only size, but also various other attributes of the target object such as, but not limited to, color, sound, shape, or any combination thereof when a user's means of touch input is within a predetermined proximity to the object.

Also, as previously mentioned, “object” includes any user interface means that is displayed on a touch screen and executes commands, functions or instructions associated with the object when selected. Examples of an object include but not limited to, icons, buttons, images, and word strings (i.e., texts). Other examples of an object include but not limited to individual input keys within an on-screen keyboard, text objects within a web page, settings menu items, and icons within a home screen displayed on the touch screen of the touch input apparatus 1000.

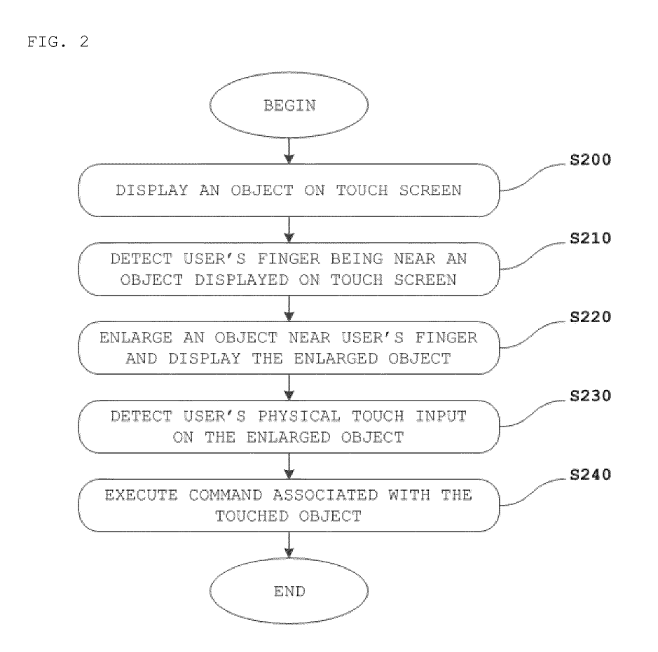

FIG. 2 is a flow chart which describes step-by-step process of the touch input apparatus acknowledging user's touch input according to an embodiment of the present invention.

In step S200, the touch input apparatus 1000 displays object on the touch screen. The touch input apparatus 1000 can display at least one object, in order to acknowledge user's touch input that executes the predetermined operation.

For example, the touch input apparatus 1000 may display multiple input keys. Also, for example, the touch input apparatus (1000) can display hyperlinked word string via the web browser. Also, for example, the touch input apparatus 1000 can display settings menu that may include multiple menu items. In this case, each field is considered as a separate object. In addition, the touch input apparatus 1000 can display icons of applications installed on the touch input apparatus 1000. However, the examples are not limited thereto.

In step S210, the touch input apparatus 1000 detects the presence of user's finger as it nears the touch screen. In other words, the touch input apparatus 1000 can detect user's finger in vicinity of an object displayed on the touch screen when the user's finger is within predetermined proximity to the touch screen while not physically touching the touch screen. The method of setting the threshold value of the proximity to determine that user's finger is near the object can vary according to embodiments.

For example, the touch input apparatus 1000 uses multiple proximity sensors to detect user's finger nearing the touch screen. Proximity sensors can be installed within the touch input apparatus 1000 in various configurations. For example, multiple proximity sensors can be placed under the touch screen in grid array. Based on values read and changes in those values, the touch input apparatus 1000 may determine whether user's finger is near the touch screen.

In another example, the touch input apparatus 1000 is able to determine whether user's finger is within predetermined proximity to the touch screen by sensing changes in electrostatic values. For example, if changes in electrostatic value of an area displaying an object are between the first and the second threshold values, the touch input apparatus 1000 determines that a user's finger is within predetermined proximity to the touch screen. In a case where multiple objects are arranged close to each other, an object which is estimated as the closest to the user's finger, according to the electrostatic method, is determined to be the desired object. Furthermore, if changes in electrostatic value of an area displaying an object are greater than the second threshold value, the touch input apparatus 1000 determines that the user's finger is physically touching the touch screen.

Meanwhile, as objects are displayed on the touch screen, the touch input apparatus 1000 automatically activates its functionality to sense whether a user's finger is within predetermined proximity to the touch screen. For example, when an on-screen keyboard is displayed on the touch screen, the touch input apparatus 1000 activates sensors to determine whether a user's finger is within predetermined proximity to the touch screen.

In step S220, the touch input apparatus 1000 enlarges the object and displays the enlarged objects on the touch screen. For example, when a user's finger is within a predetermined proximity to the button for the letter “g” within the on-screen keyboard of the touch input apparatus 1000, the touch input apparatus 1000 enlarges the button for the letter “g” within the on-screen keyboard. As shown in step S220, user can more accurately type the letter “g” using the enlarged button for the letter “g” within the on-screen keyboard.

Furthermore, in order to improve the accuracy when making a selection using the enlarged object, the touch input apparatus (1000) can reduce the size of one or more objects around the enlarged object. For example, the touch input apparatus 1000 enlarges the button for the letter “g” and at the same time reduce the size of the buttons for letters “r”, “t”, “y”, “h”, “b”, “v”, “c”, and “f” that surrounds the letter “g”.

Also, in order for users to more accurately make selections using the enlarged object, the touch input apparatus 1000 can change the spacing value between the enlarged object and one or more of its surrounding objects. Also, the spacing value between at least two objects can be changed while an object is enlarged.

In step S230, the touch input apparatus 1000 detects that the enlarged object has been touched. As mentioned previously, these touch actions can be executed using various input methods including but not limited to user's finger or stylus pen. The touch input apparatus 1000 can determine that an object has been touched by correlating the location of the displayed object with the location of the contact on the touch screen.

The method of sensing a touch action is not limited to a specific manner. For example, if changes in electrostatic value of an area displaying an object are greater than threshold value 2, the touch input apparatus 1000 determines that a user's finger is touching the touch screen. As another example, the touch input apparatus 1000 can determine the coordinates of the contact location of the touch screen by sensing the pressure applied against the touch screen and identify the object the user is touching.

In step S240, the touch input apparatus 1000 executes a command associated with, in other words, pre-assigned to the touched object. For example, when an input key within the on-screen keyboard is enlarged and then touched by the user, the letter corresponding to that input key can be typed to the touch input apparatus 1000.

In addition, for example, when a text object is enlarged and then touched by the user, a hyperlink or a file corresponding to the hyperlinked text object can either be opened or downloaded.

In addition, for example, when a menu item, which is also an object within a settings menu, is enlarged and then touched by the user, a user interface can be displayed in order to execute one or more predetermined commands associated with the touched menu item.

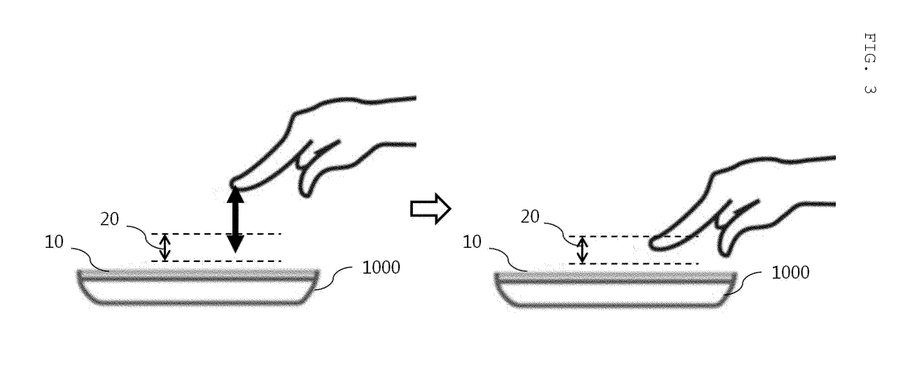

FIG. 3 is a diagram illustrating an example of the touch input apparatus 1000 detecting the presence of user's finger in vicinity of the object displayed within the touch screen according to an embodiment of the present invention. FIG. 3 illustrates a side view of the touch input apparatus 1000 placed on a table (not shown).

Referring to FIG. 3, when a user's finger nears the touch screen 10 and is within a predetermined proximity 20, the touch input apparatus 1000 identifies the user's desired object among various objects displayed on the touch screen 10 and enlarges the desired object. For example, the touch input apparatus 1000 identifies and enlarges the input key closest to the user's finger among various input keys within the on-screen keyboard displayed on the touch screen 10.

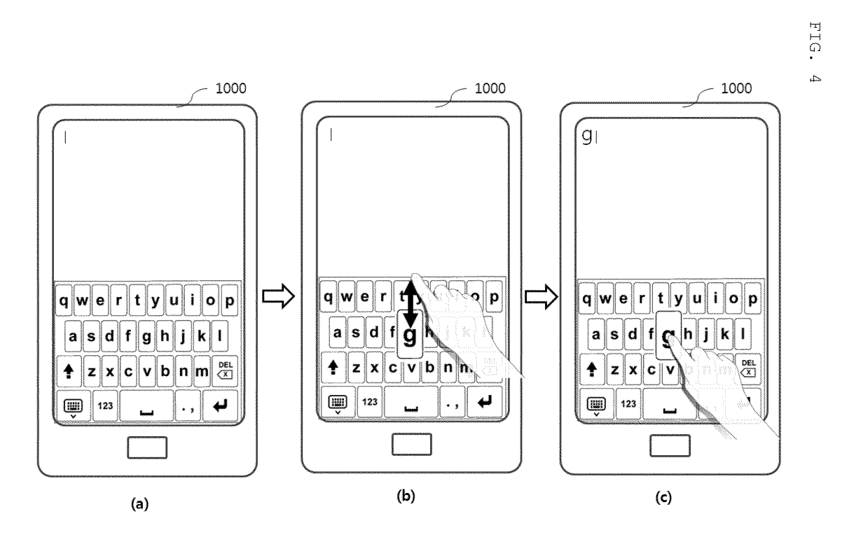

FIG. 4 is a diagram illustrating the touch input apparatus which displays an on-screen keyboard and enlarges one of the keys as user's finger approaches the key on the touch screen according to an embodiment of the present invention.

Referring to FIG. 4(a), the touch input apparatus 1000 can display the on-screen keyboard on the touch screen. In addition, input keys within the on-screen keyboard can be arranged according to a preset configuration.

Referring to FIG. 4(b), the touch input apparatus 1000 senses the user's finger nearing the button for the letter “g” within the on-screen keyboard and enlarges the button for the letter “g”. The enlarged button for the letter “g” should desirably be located overlapping the original “g” button. In FIG. 4(b), the weighted double arrow is not a depiction of user's finger touching the button for the letter “t” or “y”, but a three dimensional depiction of user's finger placed above the button for the letter “g” without physically touching the touch screen. Weighted double arrows in other figures contained within this specification should be interpreted in the same manner.

As illustrated in FIG. 4(c), when the user's finger touches the button for the letter “g” on the on-screen keyboard, the touch input apparatus 1000 enters the letter “g”, the corresponding letter input for the button.

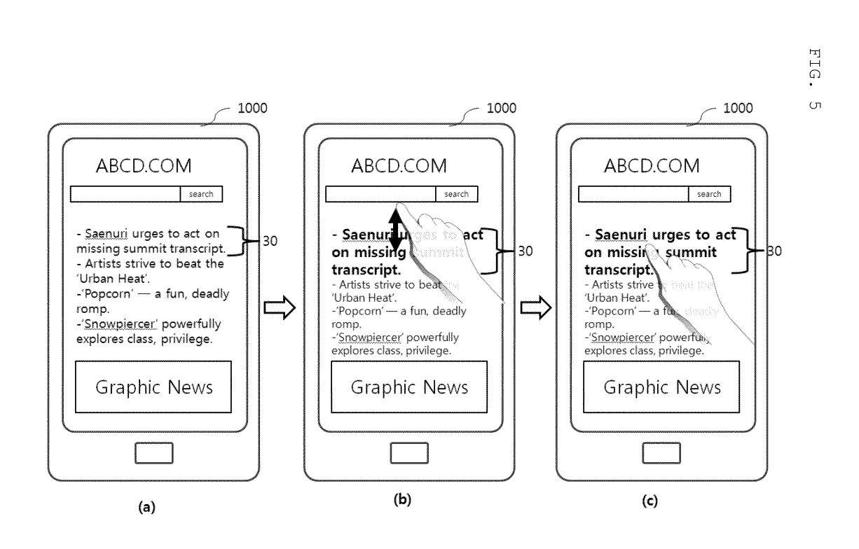

FIG. 5 is a diagram illustrating the touch input apparatus which displays a web page and enlarges a text object of the web page as user's finger approaches the text object on the touch screen according to an embodiment of the present invention.

Referring to FIG. 5(a), the touch input apparatus 1000 can display a web page that contains multiple text objects. In addition, referring to FIG. 5(b), the touch input apparatus 1000 can detect the presence of the user's finger above the word string within a web page. When the touch input apparatus 1000 senses the user's finger approaching the touch screen, the touch input apparatus 1000 can enlarge the text object 30. In addition, for example, the touch input apparatus 1000 enlarges the text object (30) and bolds the enlarged text object 30. Furthermore, the touch input apparatus 1000 can enlarge the text object 30 and reduce the size of other text objects within the web page. However, it is not limited thereto.

Referring to FIG. 5(c), when the user's finger touches the text object 30, the touch input apparatus 1000 displays the web page (not shown) linked to the word string 30.

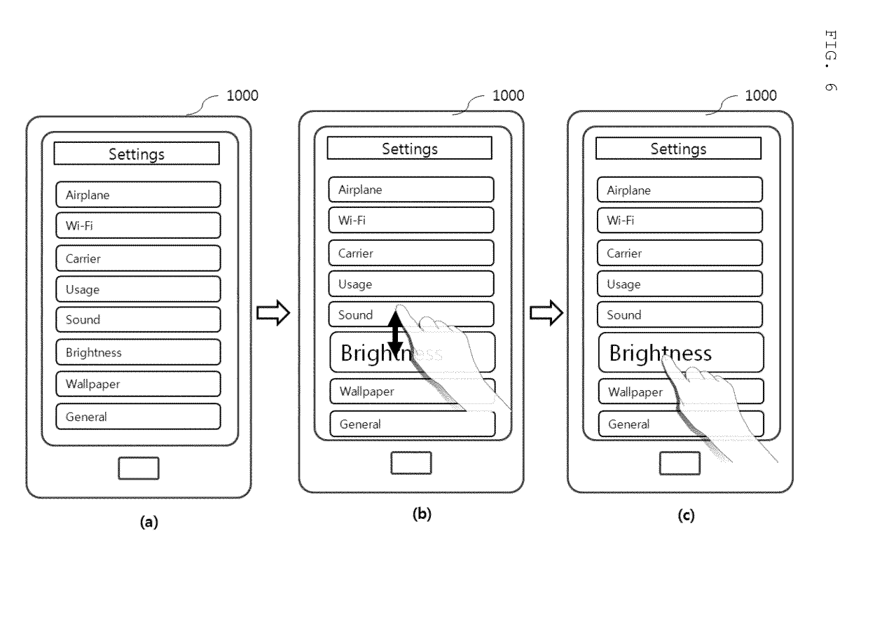

FIG. 6 is a diagram illustrating the touch input apparatus which displays a settings menu comprising multiple menu items and enlarges one of the items as user's finger approaches the menu item on the touch screen according to an embodiment of the present invention.

Referring to FIG. 6(a), the touch input apparatus 1000 can display settings menu which allows users to change setting values. In addition, referring to FIG. 6(b), the touch input apparatus 1000 detects the presence of the user's finger above the “Brightness” field. The touch input apparatus 1000 can enlarge the “Brightness” menu item as the touch input apparatus 1000 detects the presence of the user's finger above the menu item on the touch screen.

Referring to FIG. 6(c), the touch input apparatus 1000 detects that the user's finger touched the “Brightness” item of the settings menu. In addition, when the user's finger touches the “Brightness” item, the touch input apparatus 1000 can display user interface that enables users to change brightness settings.

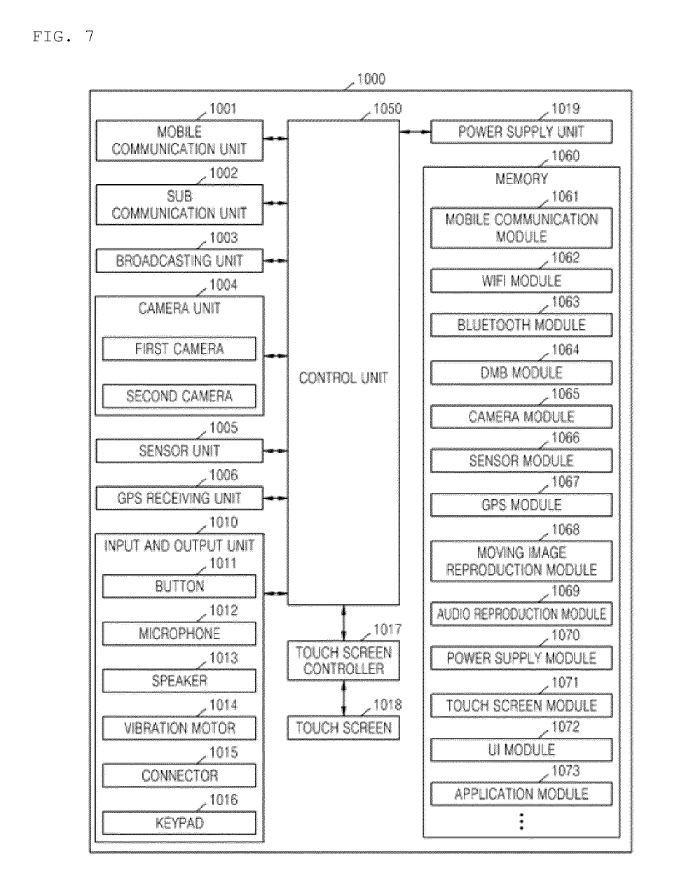

FIG. 7 is a block diagram of the mobile terminal 1000 according to an exemplary embodiment.

The mobile terminal 1000 may include a mobile communication unit 1001, a sub communication unit 1002, a broadcasting unit 1003, a camera unit 10004, a sensor unit 1005, a global positioning system (GPS) receiving unit 1006, an input and output (I/O) unit 1010, a touch screen controller 1017, a touch screen 1018, a power supply unit 1019, a control unit 1050 (CPU), and a memory 1060.

The mobile communication 1001 performs call set up, data communication, etc. with a base station through a cellular network, such as a third Generation (3G) or fourth Generation (4G) network. The sub communication unit 1002 performs communication, such as near field communication (NFC), Zigbee, Wi-Fi, or Bluetooth network communication. A broadcasting unit 1003 receives a digital multimedia broadcasting (DMB) signal.

The camera unit 1004 includes a lens and optical devices for capturing a still image or a moving image.

The sensor unit 1005 may include a gravity sensor for detecting movement of the mobile terminal 1000, an illumination sensor for detecting brightness of light, a proximity sensor for detecting a proximity degree of a person, and a motion sensor for detecting movement of the person.

The global positioning system (GPS) receiving unit 1006 receives a GPS signal from a satellite. Various services may be provided to the user by using such a GPS signal.

The input and output unit 1010 provides an interface with an external device or a person, and includes a button 1011, a microphone 1012, a speaker 1013, a vibration motor 1014, a connector 1015, and a keypad 1016.

A touch screen 1018 receives a touch input of the user. Also, a touch screen controller 1017 transmits the touch input received through the touch screen 1018 to a control unit 1050. A power supply unit 1019 is connected to a battery or an external power source to supply power to the mobile terminal 1000.

The control unit 1050 controls the mobile terminal 1000 and executes programs stored in a memory 1060.

The programs stored in the memory 1060 may be classified into a plurality of modules according to functions. In other words, the programs may be classified into a mobile communication module 1061, a Wi-Fi module 1062, a Bluetooth module 1063, a DMB module 1064, a camera module 1065, a sensor module 1066, a GPS module 1067, a moving image reproduction module 1068, an audio reproduction module 1069, a power supply module 1070, a touch screen module 1071, a user interface (UI) module 1072, and an application module 1073.

Since functions of each module may be intuitively inferred by one of ordinary skill in the art based on its name, only application module 1073 is further described below.

The application module 1073 displays objects on the touch screen. The application module 1073 can display objects on the touch input apparatus 1000 in order to receive touch input that executes the corresponding operations.

In addition, the application module 1073 detects the presence of the user's finger above the object. The application module 1073 can detect the presence of the user's finger within predetermined proximity to the touch screen without physically touching the touch screen by interacting with the touch screen controller (1017). Also, the application module 1073 can activate the functionality to determine whether a user's finger is within predetermined proximity to the touch screen as objects are displayed on the touch screen 1018.

In addition, the application module 1073 enlarges the object and displays the enlarged objects on the touch screen 1018. The application module 1073 can overlap the enlarged object to the original object (object before it was enlarged). However, it is not limited thereto. The application module 1073 may enlarge an object and change the spacing value between the enlarged object and one or more of its surrounding objects. Also, the application module 1073 may reduce the size of one or more objects around the enlarged object.

In addition, the application module 1073 senses the user's finger touching the enlarged object. The application module 1073 may identify the desired object among many objects by correlating the locations of displayed objects with the location of the contact on the touch screen 1018.

In addition, the application module 1073 executes the command corresponding to the enlarged object when the user physically touches it on the touch screen. For example, when an input key within the on-screen keyboard is enlarged and then touched by the user, the letter corresponding to that input key can be entered to the touch input apparatus 1000.

In addition, for example, when a text object is enlarged and then touched by the user, the touch input apparatus 1000 can display a hyperlinked web page or download a file corresponding to the hyperlinked text object.

In addition, for example, when an item within a settings menu is enlarged and then touched by the user, the touch input apparatus can display a user interface that enable users to execute one or more commands corresponding to the touched menu item.

The one or more embodiments of the present invention may be embodied as a recording medium, e.g., a program module to be executed in computers, which include computer-readable commands. The computer storage medium may include any usable medium that may be accessed by computers, volatile and non-volatile mediums, and detachable and non-detachable mediums. Also, the computer storage medium may include a computer storage medium and a communication medium. The computer storage medium includes volatile and non-volatile mediums, and detachable and non-detachable mediums, which are designed to store information including computer readable commands, data structures, program modules or other data. The communication medium includes computer-readable commands, a data structure, a program module, and other transmission mechanism, and includes other information transmission mediums.

Embodiments of the present invention may, however, be embodied in many different forms and should not be construed as being limited to the embodiments set forth herein. Rather, these embodiments of the present invention are provided so that this disclosure will be thorough and complete, and will fully convey the inventive concept to those of ordinary skill in the art. For example, configuring elements that are singular forms may be executed in a distributed fashion, and also, configuring elements that are distributed may be combined and then executed.

While the present invention has been shown and described with reference to certain embodiments thereof, it will be understood by those of ordinary skill in the art that various changes in form and detail may be made therein without departing from the spirit and scope of the present invention as defined by the following claims.

1. A method performed by a device to provide a user interface, the method comprising the steps of:
enlarging an object on a touch screen, in response to detecting the presence of a user's means of touch input within a predetermined proximity to the object displayed on the touch screen with the user's means of touch input not physically touching the touch screen; and
executing one or more predetermined commands associated with the object, in response to a touch input touching the enlarged object on the touch screen.

2. The method of claim 1,
wherein the object is an input key within the on-screen keyboard and wherein executing the one or more predetermined commands comprises entering a value assigned to the input key into an input field.

3. The method of claim 2, further including,
automatically activating a function of detecting proximity of the user's means of touch input when the on-screen keyboard is displayed on the touch screen.

4. The method of claim 1,
wherein enlarging the object includes determining whether the user's means of touch input is within predetermined proximity based on electrostatic changes on the touch screen caused by the user's means of touch input.

5. The method of claim 1,
wherein enlarging the object includes determining whether the user's means of touch input is within predetermined proximity by using one or more proximity sensors.

6. The method of claim 1,
wherein enlarging the object includes changing at least one spacing between other objects while the enlarged object is displayed.

7. The method of claim 1,
wherein enlarging the object includes reducing the size of one or more objects around the enlarged object while the enlarged object is displayed.

8. An apparatus comprising:
a touch screen;
a memory unit storing one or more programs; and
a processor that provides a user interface by executing the one or more program,
wherein the one or more program include instructions implementing the steps of:
enlarging the object displayed on the touch screen, in response to detecting the presence of a user's means of touch input within a predetermined proximity to the object displayed on the touch screen with the user's means of touch input not physically touching the touch screen; and
executing one or more predetermined commands associated with the object, in response to a touch input touching the enlarged object on the touch screen.

9. The apparatus of claim 8,
wherein the object is an input key within the on-screen keyboard and wherein executing the one or more predetermined commands comprises entering a value assigned to the input key into an input field.

10. The apparatus of claim 9,
wherein the one or more program further include instructions implementing the step of automatically activating a function of detecting proximity of the user's means of touch input when the on-screen keyboard is displayed on the touch screen.

11. The apparatus of claim 8,
wherein enlarging the object includes determining whether the user's means of touch input is within predetermined proximity based on electrostatic changes on the touch screen caused by the user's means of touch input.

12. The apparatus of claim 8,
wherein enlarging the object includes determining whether the user's means of touch input is within predetermined proximity by using one or more proximity sensors.

13. The apparatus of claim 8,
wherein enlarging the object includes changing at least one spacing between other objects while the enlarged object is displayed.

14. The apparatus of claim 8,
wherein enlarging the object includes reducing the size of one or more objects around the enlarged object while the enlarged object is displayed.

15. A non-transitory computer readable recording medium having embodied thereon a computer program for executing the method of claim 1.
